(19) United States
(12) Patent Application Publication
(10) Pub. No.: US 2024/0291777 A1
(43) Pub. Date: Aug. 29, 2024

(54) CHATBOT TO RECEIVE FIRST NOTICE OF LOSS

(71) Applicant: STATE FARM MUTUAL AUTOMOBILE INSURANCE COMPANY, Bloomington, IL (US)

(72) Inventors: Brian Fields, Phoenix, AZ (US); Nathan L. Tofte, Downs, IL (US); Joseph Robert Brannan, Bloomington, IL (US); Vicki King, Bloomington, IL (US); Justin Davis, Bloomington, IL (US)

(21) Appl. No.: 18/201,604

(22) Filed: May 24, 2023

Related U.S. Application Data
(60) Provisional application No. 63/486,506, filed on Feb. 23, 2023.
(60) Provisional application No. 63/488,633, filed on Mar. 6, 2023.
(60) Provisional application No. 63/490,136, filed on Mar. 14, 2023.

(51) Int. Cl. H04L 51/02; G06Q 40/08

(52) U.S. Cl. CPC H04L 51/02; G06Q 40/08

(57) ABSTRACT

Receiving a first notice of loss (FNOL) using a machine learning (ML) chatbot (or voice bot) when initiating an FNOL session with a user device to obtain FNOL information. Generating one or more requests for claim information by the ML chatbot based upon the FNOL information to provide to the user device during the FNOL session. Receiving the claim information by the ML chatbot from the user device based upon the one or more requests for the claim information. Analyzing information from the FNOL session to determine one or more session actions and implementing the one or more session actions.

### CROSS-REFERENCE TO RELATED APPLICATIONS

This application claims priority to and the benefit of the filing date of (1) provisional U.S. Patent Application No. 63/486,506 entitled “CHATBOT TO RECEIVE FIRST NOTICE OF LOSS,” filed on Feb. 23, 2023; (2) provisional U.S. Patent Application No. 63/488,633 entitled “CHATBOT TO RECEIVE FIRST NOTICE OF LOSS,” filed on Mar. 6, 2023; and (3) provisional U.S. Patent Application No. 63/490,136 entitled “CHATBOT TO RECEIVE FIRST NOTICE OF LOSS.” filed on Mar. 14, 2023. The entire contents of each of which is hereby expressly incorporated herein by reference.

### FIELD OF THE INVENTION

The present disclosure generally relates to receiving a first notice of loss for an insurance claim, and more particularly, receiving the first notice of loss from a user via a machine learning chatbot.

### BACKGROUND

A first notice of loss (FNOL) may be an initial report a policyholder provides to their insurance carrier following the theft, loss, and/or damage to an insured asset as a first step in the claims process. The FNOL may require general information from the policyholder, such as the date and time of the loss, whether a police report is filed, the location of the loss, an explanation of the loss, among other things. The FNOL may further require additional, more specific information based upon the type of loss, insurance policy/type of coverage, the state in which the loss occurs, etc., which may warrant an intelligent assessment of the specific circumstances surrounding the loss to ensure the FNOL captures the necessary information. This may involve the policyholder and/or representative of the insurance carrier to expend time and effort evaluating what questions may be necessary to ask, what forms may need to be completed, among other things, running the risk of omitting potentially necessary information and/or actions to effectively complete the FNOL. The conventional FNOL reporting techniques may include additional ineffectiveness, inefficiencies, encumbrances, and/or other drawbacks.

### SUMMARY

The present embodiments may relate to, inter alia, systems and methods for receiving a first notice of loss (FNOL) using a machine learning (ML) and/or artificial intelligence (AI) chatbot (or voice bot).

In one aspect, a computer-implemented method for receiving a first notice of loss (FNOL) using a machine learning (ML) chatbot (or voice bot). The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer-implemented method may include: (1) initiating, by one or more processors, an FNOL session with a user device; (2) obtaining, by the one or more processors, FNOL information; (3) generating, by the one or more processors via the ML chatbot, one or more requests for claim information based upon the FNOL information; (4) providing, by the one or more processors via the ML chatbot, the one or more requests for the claim information to the user device during the FNOL session; (5) receiving, by the one or more processors via the ML chatbot, the claim information based upon the one or more requests for the claim information from the user device during the FNOL session; (6) analyzing, by the one or more processors, information from the FNOL session to determine one or more session actions; and/or (7) implementing, by the one or more processors, the one or more session actions. The method may include additional, less, or alternate functionality or actions, including those discussed elsewhere herein.

In another aspect, a computer system for receiving a first notice of loss (FNOL) using a machine learning (ML) chatbot (or voice bot). The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, and/or other electronic or electrical components, which may be in wired or wireless communication with one another. For example, in one instance, the computer system may include one or more processors configured to: (1) initiate an FNOL session with a user device; (2) obtain FNOL information; (3) generate, via the ML chatbot, one or more requests for claim information based upon the FNOL information; (4) provide, via the ML chatbot, the one or more requests for the claim information to the user device during the FNOL session; (5) receive, via the ML chatbot, the claim information based upon the one or more requests for the claim information from the user device during the FNOL session; (6) analyze information from the FNOL session to determine one or more session actions; and/or (7) implement the one or more session actions. The computer system may include additional, less, or alternate functionality, including that discussed elsewhere herein.

In another aspect, a non-transitory computer-readable medium storing processor-executable instructions that, when executed by one or more processors, cause the one or more processors to (1) initiate an FNOL session with a user device; (2) obtain FNOL information; (3) generate, via a machine learning (ML) chatbot (or voice bot), one or more requests for claim information based upon the FNOL information; (4) provide, via the ML chatbot, the one or more requests for the claim information to the user device during the FNOL session; (5) receive, via the ML chatbot, the claim information based upon the one or more requests for the claim information from the user device during the FNOL session; (6) analyze information from the FNOL session to determine one or more session actions; and/or (7) implement the one or more session actions. The instructions may direct additional, less, or alternate functionality, including that discussed elsewhere herein.

In another aspect, a computer-implemented method for receiving a first notice of loss (FNOL) using an artificial intelligence (AI) chatbot (or voice bot). The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer-implemented method may include: (1) initiating, by one or more processors, an FNOL session with a user device; (2) obtaining, by the one or more processors, FNOL information; (3) generating, by the one or more processors via the AI chatbot, one or more requests for claim information based upon the FNOL information; (4) providing, by the one or more processors via the AI chatbot, the one or more requests for the claim information to the user device during the FNOL session; (5) receiving, by the one or more processors via the AI chatbot, the claim information based upon the one or more requests for the claim information from the user device during the FNOL session; (6) analyzing, by the one or more processors, information from the FNOL session to determine one or more session actions; and/or (7) implementing, by the one or more processors, the one or more session actions. The method may include additional, less, or alternate functionality or actions, including those discussed elsewhere herein.

In another aspect, a computer system for receiving a first notice of loss (FNOL) using an artificial intelligence (AI) chatbot (or voice bot). The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT bots, and/or other electronic or electrical components, which may be in wired or wireless communication with one another. In one instance, the computer system may include one or more processors configured to: (1) initiate an FNOL session with a user device; (2) obtain FNOL information; (3) generate, via the AI chatbot, one or more requests for claim information based upon the FNOL information; (4) provide, via the AI chatbot, the one or more requests for the claim information to the user device during the FNOL session; (5) receive, via the AI chatbot, the claim information based upon the one or more requests for the claim information from the user device during the FNOL session; (6) analyze information from the FNOL session to determine one or more session actions; and/or (7) implement the one or more session actions. The computer system may include additional, less, or alternate functionality, including that discussed elsewhere herein.

In another aspect, a non-transitory computer-readable medium storing processor-executable instructions that, when executed by one or more processors, cause the one or more processors to: (1) initiate an FNOL session with a user device; (2) obtain FNOL information; (3) generate, via an artificial intelligence (AI) chatbot (or voice bot), one or more requests for claim information based upon the FNOL information; (4) provide, via the AI chatbot, the one or more requests for the claim information to the user device during the FNOL session; (5) receive, via the AI chatbot, the claim information based upon the one or more requests for the claim information from the user device during the FNOL session; (6) analyze information from the FNOL session to determine one or more session actions; and/or (7) implement the one or more session actions. The instructions may direct additional, less, or alternate functionality, including that discussed elsewhere herein.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer system in which methods and systems for receiving a first notice of loss are implemented.

FIG. 2 depicts a combined block and logic diagram in which exemplary computer-implemented methods and systems for training an ML chatbot model are implemented.

FIG. 3 depicts an exemplary display of an enterprise mobile application employing an ML chatbot.

FIG. 4 depicts a flow diagram of an exemplary computer-implemented method for receiving an FNOL using an ML chatbot.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for receiving a FNOL using a machine learning (ML) and/or artificial intelligence (AI) chatbot and/or voice bot.

Some embodiments may use techniques to initiate a session (FNOL session) between an ML/AI chatbot/voice bot and a user device to obtain FNOL information, which may include: (i) a type of claim, (ii) a user profile, and/or (iii) state requirements. Based upon the FNOL information, the AI/ML chatbot/voice bot may generate one or more requests for claim information to provide to the user device. The AI/ML chatbot/voice bot may receive the claim information in one or more responses to the one or more requests during the FNOL session. Analyzing information from the FNOL session may determine one or more session activities. The session actions may include: (1) transferring the FNOL session to a customer service device, (2) terminating the FNOL session. (3) generating and providing a summary of the FNOL session to an enterprise device, and/or (4) generating and providing an insurance claim to the enterprise device.

### Exemplary Computing Environment

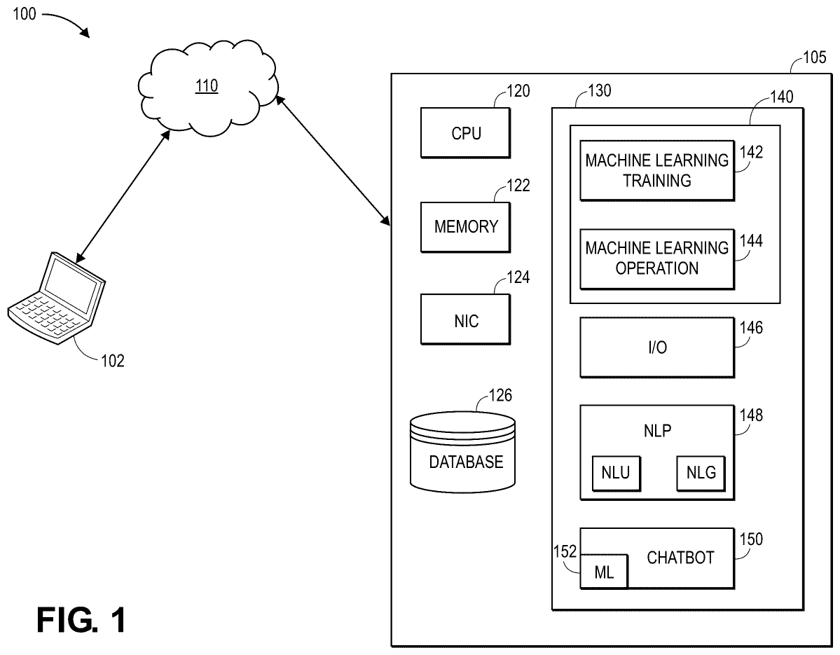

FIG. 1 depicts a block diagram of an exemplary computing environment 100 in which receiving a FNOL may be performed, in accordance with various aspects discussed herein.

In the exemplary aspect of FIG. 1, the computing environment 100 includes a user device 102. In various aspects, the user device 102 comprises one or more computers, which may comprise multiple, redundant, or replicated client computers accessed by one or more users. The computing environment 100 may further include an electronic network 110 communicatively coupling other aspects of the computing environment 100.

The user device 102 may be any suitable device and include one or more mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

As described herein and in an aspect, one or more servers 105 may perform the functionalities as part of a cloud network or may otherwise communicate with other hardware or software components within one or more cloud computing environments to send, retrieve, or otherwise analyze data or information described herein. For example, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., a business) providing a chatbot to file an FNOL may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by an enterprise receiving the FNOL. The public cloud may be partitioned using visualization and multi-tenancy techniques and may include one or more infrastructure-as-a-service (IaaS) and/or platform-as-a-service (PaaS) services.

The network 110 may comprise any suitable network or networks, including a local area network (LAN), wide area network (WAN), Internet, or combination thereof. For example, the network 110 may include a wireless cellular service (e.g., 4G, 5G, etc.). Generally, the network 110 enables bidirectional communication between the user device 102 and the servers 105. In one aspect, the network 110 may comprise a cellular base station, such as cell tower(s), communicating to the one or more components of the computing environment 100 via wired/wireless communications based on any one or more of various mobile phone standards, including NMT, GSM, CDMA, UMMTS, LTE, 5G, or the like. Additionally or alternatively, the network 110 may comprise one or more routers, wireless switches, or other such wireless connection points communicating to the components of the computing environment 100 via wireless communications based on any one or more of various wireless standards, including by non-limiting example, IEEE 802.11a/b/c/g (WIFI), Bluetooth, and/or the like.

The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database. The database 126 may store data and be used to train and/or operate one or more ML models, chatbots, and/or voice bots.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 105. For example, libraries may include the TensorFlow based library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning. unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprising a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 105 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 105 or may be indirectly accessible via or attached to the user device 102. According to an aspect, an administrator or operator may access the servers 105 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques. For instance, the voice bot or chatbot 150 may be a ChatGPT chatbot. The voice bot or chatbot 150 may employ supervised or unsupervised ML techniques, which may be followed or used in conjunction with reinforced or reinforcement learning techniques. The voice bot or chatbot 150 may employ the techniques utilized for ChatGPT.

Noted above, in some embodiments, a chatbot 150 or other computing device may be configured to implement ML, such that server 105 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

For example, in an aspect, the server 105 may initiate a chat session over the network 110 with a user via the user device 102, e.g., so the user may file the FNOL insurance claim. The chatbot 150 may receive utterances from the user, i.e., the input from the user from which the chatbot 150 needs to derive intents from. The utterances may be processed using NLP module 148 and/or ML module 140 via one or more ML models to recognize what the user says, understand the meaning, determine the appropriate action, and/or respond with language the user can understand.

In one aspect, the server 105 may host and/or provide an application (e.g., a mobile application) and/or website configured to provide the application to receive FNOL information from a user. In one aspect, the server 105 may store code in memory 122 which when executed by CPU 120 may provide the website and/or application.

In one aspect, the application may use the chatbot 150 to guide the user through a step-by-step question and answer process until the FNOL information has been captured by the server 105. In one aspect, the server 105 may store the FNOL information in the database 126. The data may be cleaned, labeled, vectorized, weighted and/or otherwise processed, especially processing suitable for data used in any aspect of ML.

In one aspect, anytime the server 105 evaluates the FNOL, the associated information may be stored in the database 126. In one aspect, the server 105 may use the stored data to generate, train and/or retrain one or more ML models and/or chatbots 150, and/or for any other suitable purpose.

In operation, ML model training module 142 may access database 126 or any other data source for training data suitable to generate one or more ML models appropriate to receive and/or process the FNOL information, e.g., an ML chatbot 152. The training data may be sample data with assigned relevant and comprehensive labels (classes or tags) used to fit the parameters (weights) of an ML model with the goal of training it by example. In one aspect, training data may include historical data from past first notices of loss. The historical data may include the type of insurance claim, user profiles, state requirements for the claim, as well as any other suitable training data. In one aspect, once an appropriate ML model is trained and validated to provide accurate predictions and/or responses, e.g., the ML chatbot 152, the trained model and/or ML chatbot 152 may be loaded into MLOM 144 at runtime, may process the user inputs and/or utterances, and may generate as an output conversational dialog.

While various embodiments, examples, and/or aspects disclosed herein may include training and generating one or more ML models and/or ML chatbot 152 for the server 105 to load at runtime, it is also contemplated that one or more appropriately trained ML models and/or ML chatbot 152 may already exist (e.g., in database 126) such that the server 105 may load an existing trained ML model and/or ML chatbot 152 at runtime. It is further contemplated that the server 105 may retrain, update and/or otherwise alter an existing ML model and/or ML chatbot 152 before loading the model at runtime.

Although the computing environment 100 is shown to include one user device 102, one server 105, and one network 110, it should be understood that different numbers of user devices 102, networks 110, and/or servers 105 may be utilized. In one example, the computing environment 100 may include a plurality of servers 105 and hundreds or thousands of user devices 102, all of which may be interconnected via the network 110. Furthermore, the database storage or processing performed by the one or more servers 105 may be distributed among a plurality of servers 105 in an arrangement known as “cloud computing.” This configuration may provide various advantages, such as enabling near real-time uploads and downloads of information as well as periodic uploads and downloads of information.

The computing environment 100 may include additional, fewer, and/or alternate components, and may be configured to perform additional, fewer, or alternate actions, including components/actions described herein. Although the computing environment 100 is shown in FIG. 1 as including one instance of various components such as user device 102, server 105, and network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 105 and user device 102 may be connected via a direct communication link (not shown in FIG. 1) instead of, or in addition to, via network 130.

### Exemplary Training of the ML Chatbot Model

An enterprise may be able to use programmable chatbots, such the chatbot 150 and/or the ML chatbot 152 (e.g., ChatGPT), to provide tailored, conversational-like customer service relevant to a line of business. The chatbot may be capable of understanding customer requests, providing relevant information, escalating issues, any of which may assist and/or replace the need for customer service assets of an enterprise. Additionally, the chatbot may generate data from customer interactions which the enterprise may use to personalize future support and/or improve the chatbot's functionality, e.g., when retraining and/or fine-tuning the chatbot.

The ML chatbot may provide advance features as compared to a non-ML chatbot, which may include and/or derive functionality from a large language model (LLM). The ML chatbot may be trained on a server, such as server 105, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in the memory 122 of the server 105) that may be required for immediate use and may keep track of the current state of the conversation and/or to understand the user's latest input in order to generate an appropriate response. Long-term memory may include persistent storage of information (e.g., on database 126 of the server 105) which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., via the ML module 140 of the server 105) which may be used by the ML chatbot, may consist of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning ML Model

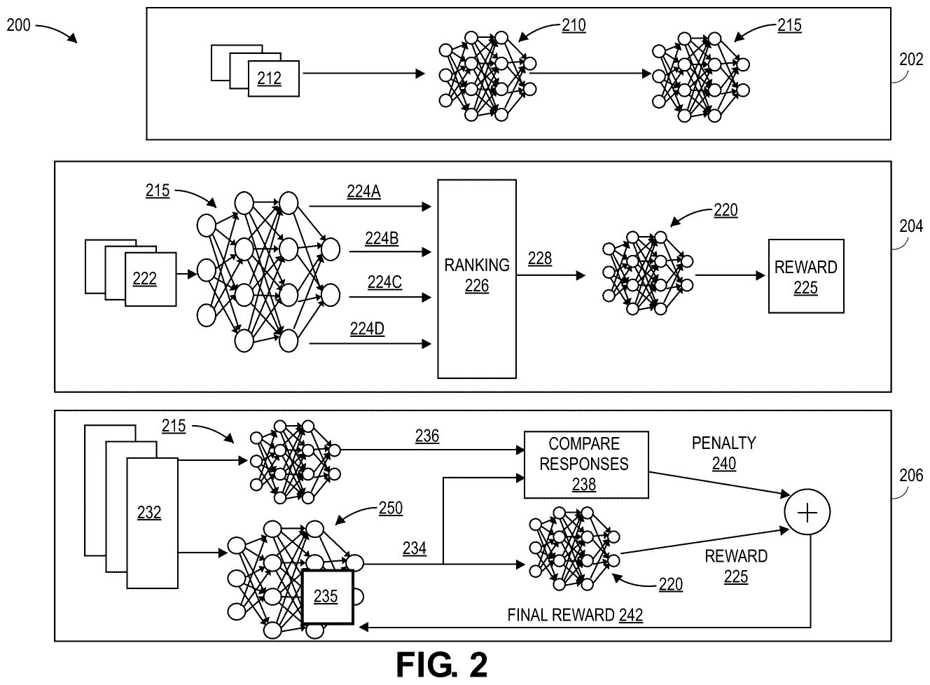

FIG. 2 depicts a combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and systems may include one or more servers 202, 204, 206, such as the server 105 of FIG. 1.

In one aspect, the server 202 may fine-tune a pretrained language model 210. The pretrained language model 210 may be obtained by the server 202 and be stored in a memory, such as memory 122 and/or database 126. The pretrained language model 210 may be loaded into an ML training module, such as MLTL 142, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 122 or the database 126. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory of the server 202, e.g., memory 122 and/or database 126.

In one aspect, the supervised training dataset 212 may include prompts and responses which may be relevant to a policyholder filing a FNOL with their insurance carrier. For example. a customer prompt may include a request to file a FNOL. Appropriate responses from the trained SFT ML model 215 may include requesting from the user the type of claim, the location of the loss, user policy information, among other things.

### Training the Reward Model

In one aspect, training the ML chatbot model 250 may include the server 204 training a reward model 220 to provide as an output a scaler value/reward 225. The reward model 220 may be required to leverage reinforcement learning with human feedback (RLHF) in which a model (e.g., ML chatbot model 250) learns to produce outputs which maximize its reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data stored on database 126, and/or any other suitable prompt data. The SFT ML model 215 may generate multiple, different output responses 224A, 224B, 224C, 224D to the single prompt 222. The server 204 may output the responses 224A, 224B, 224C, 224D via an I/O module (e.g., I/O module 146) to a user interface device, such as a display (e.g., as text responses), a speaker (e.g., as audio/voice responses), and/or any other suitable manner of output of the responses 224A, 224B, 224C, 224D for review by the data labelers.

The data labelers may provide feedback via the server 204 on the responses 224A, 224B, 224C, 224D when ranking 226 them from best to worst based upon the prompt-response pairs. The data labelers may rank 226 the responses 224A, 224B, 224C, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 236 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224C. The data labeler may rank 226, via labeling the prompt-response pairs, prompt-response pair 222/224B as the most preferred answer; prompt-response pair 222/224A as a less preferred answer; and prompt-response 222/224C as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### RLHF to Train the ML Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared 238 to the SFT ML model 215 (which may not use a policy) response 236 of the same prompt 232. The server 206 may compute a penalty 240 based upon the comparison 238 of the responses 234, 236. The penalty 240 may reduce the distance between the responses 234, 236, i.e., a statistical distance measuring how one probability distribution is different from a second, in one aspect the response 234 of the ML chatbot model 250 versus the response 236 of the SFT model 215. Using the penalty 240 to reduce the distance between the responses 234, 236 may avoid a server over-optimizing the reward model 220 and deviating too drastically from the human-intended/preferred response. Without the penalty 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward 225. The ML chatbot model 250 response 234 may be compared 238 to the SFT ML model 215 response 236 by the server 206 to compute the penalty 240. The server 206 may generate a final reward 242 which may include the scalar reward 225 offset and/or restricted by the penalty 240. The final reward 242 may be provided by the server 206 to the ML chatbot model 250 and may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

### Exemplary Computer System for Receiving the FNOL

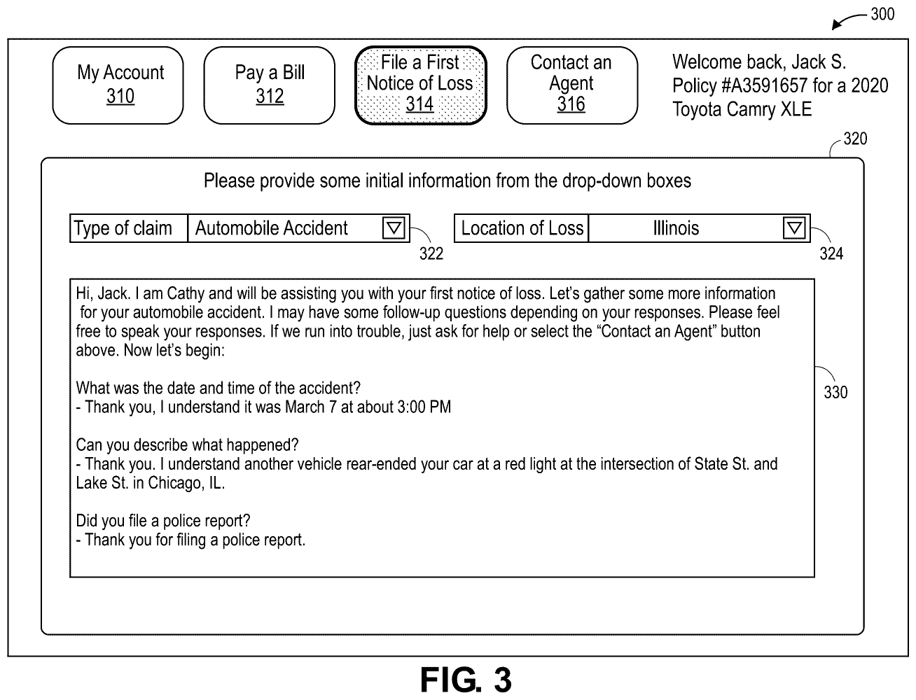

FIG. 3 depicts an exemplary display 300 of an enterprise mobile application (app) employing an ML chatbot 330 to file a FNOL, according to one embodiment. The app may be run on a user device 102 communicating with a server 105 via a network 110.

Upon experiencing a loss, a policy holder may wish to file the FNOL with their insurance carrier. In one aspect, the insurance carrier may provide a mobile app which a policyholder may use to file the FNOL via their user device 102. In the example of FIG. 3, a policyholder Jack may use his smartphone app to file the FNOL with his insurance carrier due to a vehicle accident.

The policyholder may sign into the application via the user device 102 (e.g., a smartphone, tablet, laptop) using their user credentials, such as a username and password. The user credentials may be transmitted by the user device 102 via a cellular network 110 to the insurance carrier's server 105. The server 105 may verify the policyholder's user credentials, e.g., via profile data saved on a database 126. Upon verification of the credentials by the server 105, the app may provide to the user one or more business functions associated with the enterprise, which may include filing the FNOL.

In one aspect, Jack's app may display icons 310, 312, 314, 316 associated with various business functions, one of which may allow Jack to file the FNOL for his vehicle accident via the associated FNOL icon 314. Jack may select the FNOL icon 314 via the touchscreen of his smartphone. Based upon selecting the FNOL icon 314 associated with filing the FNOL, the server 105 may initiate a session (FNOL session 320) within the app. The FNOL session 320 may include one or more of (i) audio (e.g., a telephone call), (ii) text messages (e.g., short messaging/SMS, multimedia messaging/MMS, iPhone iMessages, etc.), (iii) instant messages (e.g., real-time messaging such as a chat window), (iv) video such as video conferencing. (v) communication using virtual reality. (vi) communication using augmented reality, (vii) blockchain entries, (vii) communication in the metaverse, and/or any other suitable form of communication. The FNOL session 320 the server 105 initiates with Jack's smartphone via the app includes instant messaging and an interactive voice session where Jack is able to speak his natural language responses into the smartphone.

The mobile app may request the policyholder provide initial FNOL information associated the loss, which may indicate what other information may be relevant and/or necessary to obtain to file a FNOL. The FNOL information may include one or more of: (i) a type of insurance claim (e.g., vehicle, property, personal injury, etc.), (ii) user profile information (e.g., policyholder and/or claimant name, policy information, etc.), (iii) the state in which the loss occurred, as well as any other suitable information. At least some of the FNOL information may be available to the insurance carrier, e.g., based upon the user profile associated with the policyholder identified upon logging into the app. In one aspect, based upon Jack's user profile, the server 105 may obtain Jack's policyholder data such as name, address, date of birth, social security number, insurance policy/policies information (e.g., types of policies, account numbers, coverage information, items covered, etc.), as well as other suitable information.

The insurance carrier server 105 may request the FNOL information from the policyholder via the app via one or more of text (e.g., messaging, chat), voice (e.g., telephone call), videoconference, and/or any other suitable manner. According to FIG. 3, the app displays 300 a drop-down menu GUI for Jack to select the type of insurance claim 322 and provide the location and/or state of the loss 324.

Once the FNOL information is obtained by the server 105 via the app, and/or to also obtain the FNOL information, the server 105 may generate one or more requests for information via a chatbot 150. In one aspect, the chatbot 150 is an ML chatbot 152, although the chatbot 150 may be an AI chatbot, a voice bot and/or any other suitable chatbot/voice bot as described herein. The server 105 may select an appropriate ML chatbot 152 based upon the method of communication with the policyholder, one or more pieces of information the policyholder provides to the server 105 and/or other aspects of the FNOL. In one example, the server 105 may train (e.g., via ML module 140 and/or MLTM 142) and select one or more ML chatbots 152 to receive the FNOL from the policyholder based upon the type of loss/insurance claim. The ML chatbot 152 may operate in a conversational manner and obtain the FNOL from the policyholder without any human intervention on the part of the enterprise.

Through the one or more requests, the ML chatbot 152 may receive additional claim information from the policyholder which may be pertinent to fulfilling the FNOL and may include, but is not limited to, date and time of loss (e.g., theft, accident damage), description of the loss and/or events surround the loss, police report information, location of the incident, witness information, etc., as well as any other suitable information.

In the example according to FIG. 3, once Jack provides the type of claim 322 and location of the loss 324 during the FNOL session 320, the server 105 may initiate an ML chatbot Cathy (represented by chat window 330). The ML chatbot Cathy 330 may be a trained ML model stored on database 126 which the server 105 may load into MLOM 144 during the FNOL session 320. Once initiated, ML chatbot Cathy 330 may request the claim information from Jack in conversational nature via the app display 300. ML chatbot Cathy 330 may request claim information regarding when and where Jack's vehicle accident occurred, as well as if a police report was filed. The content of ML chatbot Cathy's 330 requests are provided as text via the FNOL session 320 chat window. In one aspect, the ML chatbot Cathy 330 may also provide audio which may sound like a human speaking the requests. Generating the audio may include NLG of NLP module 148 to convert structured responses via ML chatbot Cathy 330 into natural conversational language.

In one aspect, the server 105 may analyze and/or process the claim information received by the ML chatbot 152 via the app to interpret, understand and/or extract relevant information within one or more responses from the policyholder. In one aspect processing the claim information the ML chatbot 152 receives may include the NLP module 148 (e.g., the NLU and/or NLG modules), among other things. The ML chatbot 152 may also generate additional requests based upon the claim information it receives.

In one aspect, Jack may be able to speak his answers to the requests for claim information into the microphone of his user device 120. ML chatbot Cathy 330 may be trained and configured to interpret Jack's spoken responses. In one example, ML chatbot Cathy 330 may be trained using training data on database 126 which may include male voices describing vehicle accidents. In one example, ML chatbot Cathy 330 may have NLP processing capabilities to interpret Jack's spoken responses during the FNOL session 320, which may include accessing an NLP module such as NLP module 148.

The FNOL session 320 may generate various types of information and/or data which may include information provided by the policyholder, such as the FNOL information and/or the claim information provided in policyholder responses to the ML chatbot 152. The FNOL session information may be stored by the server 105 in memory, such as the memory 122 and/or database 126.

The FNOL session information may include data generated from an analysis of the claim information responses. In one aspect, the server 105, e.g., via NLP model 148 and/or the ML chatbot 152, may analyze the claim information for indications of policyholder sentiment, such as the emotion of the policyholder (e.g., upset, stressed, calm, frustrated, impatient, etc.). In one aspect, the FNOL session information may indicate whether the policyholder's responses may provide accurate information to fulfill the requests the ML chatbot 152 generates. Other types of suitable analysis and/or analytics may be obtained from the session information.

In one aspect, types of data the FNOL session 320 may generate may include the length of the FNOL session, which may indicate how effective the ML chatbot 152 is at gathering necessary information from the policyholder (e.g., a short session may not gather enough information; a long session may provide too much and/or inaccurate information). Another type of data the FNOL session 320 may generate may include how many requests were generated by the ML chatbot 152, which may also indicate the quality and/or effectiveness of the FNOL session 320 (e.g., too few questions may not gather enough information and too many questions may indicate ineffectiveness of the questions being asked). The number of requests may also indicate when the FNOL session 320 warrants termination, for example the ML chatbot 152 may no longer have any requests to generate which may indicate all information relevant to the FNOL may be gathered. Any suitable analytics and/or data may be generated and or analyzed from the FNOL session 320 which may indicate the quality and/or effectiveness of the FNOL session 320 and/or ML chatbot 152.

Based upon the analysis of the FNOL session information, the ML chatbot 152 may take one or more actions. In one aspect, based upon the analysis of the FNOL session information, the ML chatbot 152 may generate an insurance claim. In one aspect, the ML chatbot 152 may file the insurance claim and/or providing the insurance claim to a representative of an enterprise for review. In one aspect, the ML chatbot 152 may terminate the FNOL session 320 and/or transfer the FNOL session 320 (e.g., to a CSR of the insurance carrier). In one aspect, the ML chatbot 152 may detect the policyholder would prefer customer service from a human, such the CSR. In one example, Jack may request to speak with the CSR using the “Contact an Agent” icon 216 or ask the ML chatbot Cathy 330 for help, which may involve transferring the FNOL session 320 to the CSR. The ML chatbot 152, such as Cathy 330, may take one or more actions which may include transferring the FNOL session 320 to the CSR using the same and/or different method of communication in which the FNOL session 320 is being carried out with the policyholder (e.g., text, video, chat, telephone, etc.). In one aspect, the ML chatbot 152 may inform the policyholder it may end the FNOL session 320 and the CSR may be contacting them thereafter, e.g., by initiating a new session between the CSR and the policyholder.

In one aspect, the ML chatbot 152 may provide a summary of the policyholder interaction up until the point of transfer and/or termination of the FNOL session 320. In one example, the summary may be provided for the CSR to provide background information on what transpired during the FNOL session 320 in advance of communicating with the policyholder. The ML chatbot 152 may provide the summary via any medium of communication, such as text, voice, images, etc. The summary may include the FNOL information, the requests for claim information, the responses received in light of the requests, the FNOL session information, policyholder sentiment, policyholder profile information, recommendations for the CSR, as well as any other suitable information. In one aspect, the ML chatbot 152 may create the summary of the FNOL session 320 and provide the summary to an enterprise device, e.g., storing the summary in the database 126, emailing a transcript of the summary, etc. In one aspect, the summary information may be used to retrain and/or fine-tune the ML chatbot 152, e.g., via MLTM 142.

In one aspect, the ML chatbot 152 may determine a confidence level at one or more instances during the FNOL session 320. The confidence level and/or score, which may be a number between 0 and 1, may represent the likelihood that the output of an ML chatbot/model is correct and will satisfy a user's request. As the output of ML models/systems may include one or more predictions, each prediction may have a confidence score wherein the higher the score, the more confident the ML is that the prediction may satisfy the user's request. In conversational AI/ML which may include an ML chatbot 152, one or more stages may process the request and/or input of a user. In one aspect, during NLU, the ML chatbot 152 may predict the user intent (what the user is looking for) from an utterance/prompt (what the user may say or type). In one aspect, during sentiment and/or emotion analysis, the ML chatbot 152 may predict the sentiment (e.g., positive, negative, or neutral) and/or the emotion of the user based upon the user utterance and/or the conversation (back and forth between the user and the agent) transcript. In one aspect, during NLG, the ML chatbot 152 may predict what to respond based upon the user utterance/prompt. One or more of these predictions may have an associated confidence score/level.

In one aspect, the server 105 and/or ML chatbot 152 may determine the confidence level based upon the interactions between the ML chatbot 152 and the policyholder during the FNOL session 320, e.g., how accurately does it seem the ML chatbot 152 is able to interpret the policyholder responses, how effective are ML chatbot 152 requests, and/or other suitable metrics and/or analysis of the FNOL session 320 to determine the confidence level of the ML chatbot 152. In one aspect, the ML chatbot 152 confidence level may be compared to a threshold confidence level (e.g., which may also be a value between 0 and 1) by the server 105 and/or ML chatbot 152. If the ML chatbot 152 confidence level falls below the threshold, one or more actions may be taken by the server 105 and/or ML chatbot 152, such as ending the FNOL session 320, using a different ML chatbot 152 to continue the FNOL session 302 (e.g., one which may be trained to more effectively assist the policyholder), transferring the FNOL session 320 to a CSR, and/or any other suitable action as may be described herein.

### Exemplary Method for Receiving a First Notice of Loss Using ML

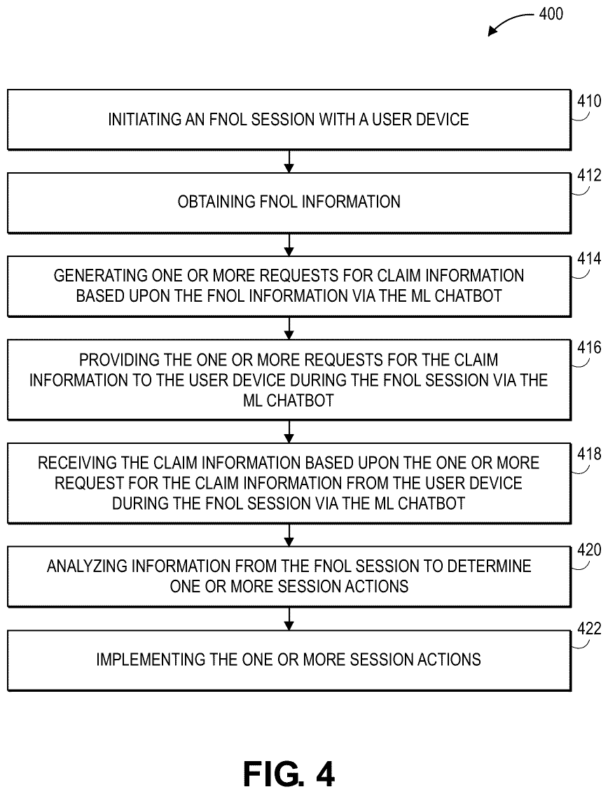

FIG. 4 depicts a flow diagram of an exemplary computer-implemented method 400 for receiving a first notice of loss (FNOL) using a machine learning (ML) chatbot (or voice bot), according to one embodiment. One or more steps of the method 400 may be implemented as a set of instructions stored on a computer-readable memory and executable on one or more processors. The method 400 of FIG. 4 may be implemented via the exemplary computer environment 100 of FIG. 1.

The computer-implemented method 400 may include: (1) at block 410 initiating, by one or more processors, an FNOL session with a user device; (2) at block 412 obtaining, by the one or more processors, FNOL information; (3) at block 414 generating, by the one or more processors via the ML chatbot, one or more requests for claim information based upon the FNOL information; (4) at block 416 providing, by the one or more processors via the ML chatbot, the one or more requests for the claim information to the user device during the FNOL session; (5) at block 418 receiving, by the one or more processors via the ML chatbot, the claim information based upon the one or more requests for the claim information from the user device during the FNOL session; (6) at block 420 analyzing, by the one or more processors, information from the FNOL session to determine one or more session actions; and/or (7) at block 422 implementing, by the one or more processors, the one or more session actions.

In one embodiment of the computer-implemented method 400, the FNOL information may include one or more of: (i) a type of claim, (ii) a user profile, and/or (iii) state requirements, as described herein.

In one embodiment of the computer-implemented method 400, analyzing the information from the FNOL session at block 420 may indicate one or more of: (i) a duration of the FNOL session, (ii) a quantity of the one or more requests for claim information, (iii) a quality of the claim information, (iv) a sentiment of the user, and/or (v) an ML chatbot confidence level. The computer-implemented method may further include obtaining, by the one of more processors, a confidence level threshold; and/or determining, by the one or more processors, whether the ML chatbot confidence level falls below the confidence level threshold.

In one embodiment of the computer-implemented method 400, the FNOL session may include one or more of: (i) audio, (ii) a text message, (iii) an instant message, (iv) a video, (v) a virtual reality, (vi) an augmented reality, (vii) a blockchain, and/or (vii) a metaverse.

In one embodiment of the computer-implemented method 400, the one or more session actions may include transferring, by the one or more processors, the FNOL session to a customer service device; and/or initiating, by the one or more processors, a second FNOL session between the user device and the customer service device.

In one embodiment of the computer-implemented method 400, the one or more session actions may include terminating, by the one or more processors, the FNOL session.

In one embodiment of the computer-implemented method 400, the one or more session actions may include generating, by the one or more processors via the ML chatbot, a summary based upon the information from the FNOL session; and/or providing, by the one or more processors via the ML chatbot, the summary to an enterprise device.

In one embodiment of the computer-implemented method 400, the one or more session actions may include generating, by the one or more processors via the ML chatbot, an insurance claim based upon the information from the FNOL session; and/or providing, by the one or more processors via the ML chatbot, the insurance claim to an enterprise device.

It should be understood that not all blocks of the exemplary flow diagram 400 are required to be performed. Moreover, the exemplary flowchart 400 is not mutually exclusive (e.g., block(s) from exemplary flow diagram 400 may be performed in any particular implementation).

### Additional Considerations

As used herein, the term “indicia” means both singular and plural. For example, the phrase “property inspection indicia” may mean either of a single property inspection indicium (e.g., a single leaking pipe) or multiple property inspection indicia (e.g., multiple leaking pipes, or a single leaking pipe and a building code violation, etc.).

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A computer-implemented method for receiving a first notice of loss (FNOL) using a machine learning (ML) chatbot, the method comprising:
initiating, by one or more processors, an FNOL session with a user device;
obtaining, by the one or more processors, FNOL information;
generating, by the one or more processors via the ML chatbot, one or more requests for claim information based upon the FNOL information;
providing, by the one or more processors via the ML chatbot, the one or more requests for the claim information to the user device during the FNOL session;
receiving, by the one or more processors via the ML chatbot, the claim information based upon the one or more requests for the claim information from the user device during the FNOL session;
analyzing, by the one or more processors, information from the FNOL session to determine one or more session actions; and
implementing, by the one or more processors, the one or more session actions.

2. The computer-implemented method of claim 1, wherein the FNOL information includes one or more of: (i) a type of claim, (ii) a user profile, and/or (iii) state requirements.

3. The computer-implemented method of claim 1, wherein analyzing the information from the FNOL session indicates one or more of: (i) a duration of the FNOL session, (ii) a quantity of the one or more requests for claim information, (iii) a quality of the claim information, (iv) a sentiment of the user, and/or (v) an ML chatbot confidence level.

4. The computer-implemented method of claim 3, further comprising:
obtaining, by the one of more processors, a confidence level threshold; and
determining, by the one or more processors, whether the ML chatbot confidence level falls below the confidence level threshold based upon one or more interactions between the user and the ML chatbot, the ML chatbot confidence level indicating a level of confidence that an output of the ML chatbot during the FNOL session is correct and/or satisfies a user request.

5. The computer-implemented method of claim 1, wherein the FNOL session includes one or more of: (i) audio, (ii) a text message, (iii) an instant message, (iv) a video, (v) a virtual reality, (vi) an augmented reality, (vii) a blockchain, and/or (vii) a metaverse.

6. The computer-implemented method of claim 1, wherein the one or more session actions comprise:
transferring, by the one or more processors, the FNOL session to a customer service device; and/or initiating, by the one or more processors, a second FNOL session between the user device and the customer service device.

7. The computer-implemented method of claim 1, wherein the one or more session actions comprise terminating, by the one or more processors, the FNOL session.

8. The computer-implemented method of claim 1, wherein the one or more session actions comprise:
generating, by the one or more processors via the ML chatbot, a summary based upon the information from the FNOL session; and
providing, by the one or more processors via the ML chatbot, the summary to an enterprise device.

9. The computer-implemented method of claim 1, wherein the one or more session actions comprise:
generating, by the one or more processors via the ML chatbot, an insurance claim based upon the information from the FNOL session; and
providing, by the one or more processors via the ML chatbot, the insurance claim to an enterprise device.

10. A computer system for receiving a first notice of loss (FNOL) using a machine learning (ML) chatbot, the computer system comprising:
one or more processors configured to:
initiate an FNOL session with a user device;
obtain FNOL information;
generate, via the ML chatbot, one or more requests for claim information based upon the FNOL information;
provide, via the ML chatbot, the one or more requests for the claim information to the user device during the FNOL session;
receive, via the ML chatbot, the claim information based upon the one or more requests for the claim information from the user device during the FNOL session;
analyze information from the FNOL session to determine one or more session actions; and
implement the one or more session actions.

11. The computer system of claim 10, wherein the FNOL information includes one or more of: (i) a type of claim, (ii) a user profile, and/or (iii) state requirements.

12. The computer system of claim 10, wherein to analyze the information from the FNOL session indicates one or more of: (i) a duration of the FNOL session, (ii) a quantity of the one or more requests for claim information, (iii) a quality of the claim information, (iv) a sentiment of the user, and/or (v) an ML chatbot confidence level.

13. The computer system of claim 12, wherein the one or more processors are further configured to:
obtain a confidence level threshold; and
determine whether the ML chatbot confidence level falls below the confidence level threshold based upon one or more interactions between the user and the ML chatbot, the ML chatbot confidence level indicating a level of confidence that an output of the ML chatbot during the FNOL session is correct and/or satisfies a user request.

14. The computer system of claim 10, wherein the FNOL session includes one or more of: (i) audio, (ii) a text message, (iii) an instant message, (iv) a video, (v) a virtual reality, (vi) an augmented reality, (vii) a blockchain, and/or (vii) a metaverse.

15. The computer system of claim 10, wherein the one or more session actions include:
transferring the FNOL session to a customer service device; and/or initiating a second FNOL session between the user device and the customer service device.

16. The computer system of claim 10, wherein the one or more session actions include terminating the FNOL session.

17. The computer system of claim 10, wherein the one or more session actions include:
generating, via the ML chatbot, a summary based upon the information from the FNOL session; and
providing, via the ML chatbot, the summary to an enterprise device.

18. The computer system of claim 10, wherein the one or more session actions include:
generating, via the ML chatbot, an insurance claim based upon the information from the FNOL session; and
providing, via the ML chatbot, the insurance claim to an enterprise device.

19. A non-transitory computer-readable medium storing processor-executable instructions that, when executed by one or more processors, cause the one or more processors to:
initiate an FNOL session with a user device;
obtain FNOL information;
generate, via a machine learning (ML) chatbot (or voice bot), one or more requests for claim information based upon the FNOL information;
provide, via the ML chatbot, the one or more requests for the claim information to the user device during the FNOL session;
receive, via the ML chatbot, the claim information based upon the one or more requests for the claim information from the user device during the FNOL session;
analyze information from the FNOL session to determine one or more session actions; and
implement the one or more session actions.

20. The non-transitory computer-readable medium of claim 19, wherein the FNOL information includes one or more of: (i) a type of claim, (ii) a user profile, and/or (iii) state requirements.
